(19) United States
(12) Patent Application Publication
(10) Pub. No.: US 2020/0062062 A1
(43) Pub. Date: Feb. 27, 2020

(54) TOP MOUNT ASSEMBLY AND MANUFACTURING METHOD THEREFOR

(71) Applicant: ILJIN CO., LTD., Gyeongiu-si Gyeongsangbuk-do (KR)

(72) Inventors: Se Woong JEONG, Gyeongju-si Gyeongsangbuk-do (KR); Ig Jin KWON, Gyeongju-si Gyeongsangbuk-do (KR); Young In YOON, Gyeongju-si Gyeongsangbuk-do (KR); Byung Hwan KIM, Gyeongju-si Gyeongsangbuk-do (KR)

(73) Assignee: ILJIN CO., LTD., Gyeongju-si Gyeongsangbuk-do (KR)

(21) Appl. No.: 16/665,356

(22) Filed: Oct. 28, 2019

Related U.S. Application Data
(63) Continuation of application No. PCT/KR2018/005006, filed on Apr. 30, 2018.

(30) Foreign Application Priority Data
Apr. 28, 2017 (KR) 10-2017-0055676

(51) Int. Cl. B60G 15/02; F16C 27/06; F16C 33/76

(52) U.S. Cl. CPC B60G 15/02; F16C 27/066; F16C 2326/05; B60G 2204/418; B60G 2204/41; F16C 33/76

(57) ABSTRACT

A top mount assembly according to one aspect of the present disclosure may comprise: an insulator comprising an elastic body and disposed between a vehicle body and a strut; and a strut bearing comprising an upper housing comprising at least one hole through which a portion of the elastic body passes, a lower housing, and a bearing disposed between the upper housing and the lower housing. The elastic body may comprise an elastic protrusion protruding downwards from the hole. The lower housing may comprise a groove which extends along the circumferential direction such that the elastic protrusion is inserted into the groove and is positioned at the radial inner side of the bearing. The elastic protrusion is inserted into the groove to seal between the upper housing and the lower housing at the radial inner side of the bearing.

### CROSS-REFERENCE TO RELATED APPLICATION

This application is a continuation of International Patent Application No. PCT/KR2018/005006 filed on Apr. 30, 2018, which claims priority to Korean Patent Application No. 10-2017-0055676 filed on Apr. 28, 2017, the entire contents of which are herein incorporated by reference.

### TECHNICAL FIELD

The present disclosure relates to a top mount assembly and a manufacturing method thereof. The present disclosure has been derived from a study conducted as Carbon Industry Foundation Development Project of Korea Evaluation Institute of Industrial Technology of Ministry of Trade, Industry and Energy. [Project Number: 10083624, Ministry Name: Ministry of Trade, Industry and Energy, Research Organization: Korea Evaluation Institute of Industrial Technology, Research Project Name: Carbon Industry Foundation Development Project, Research Subject Name: Development of vehicle suspension module using rapid curing carbon composite material high speed molding technology, Contribution Ratio: 1/1, Managing Department: ILJIN CO., LTD., and Research Period: Oct. 1, 2017˜Dec. 31, 2019]

### BACKGROUND

A suspension system of a vehicle is a system which supports a weight of a vehicle body and reduces a vertical vibration of a wheel to improve ride comfort, prevent damage to a cargo due to an impact, and prevent an excessive load from acting on each part. A front suspension system of an individual suspension type include the a wishbone type suspension system and a McPherson type suspension system. The McPherson type suspension system has been widely used in a passenger car due to a simplified structure and low cost as compared to the wishbone type suspension system.

A strut having a shock absorber embedded therein and a coil spring provided outside is used in the McPherson type suspension system. An upper end of the strut is coupled to the vehicle body through a top mount assembly and a lower end thereof is coupled to a knuckle. The strut is configured to be rotated relative to the vehicle body according to steering of the wheel. The top mount assembly comprises an insulator having an outer portion made of a rubber material and a strut bearing fitted into the insulator. The insulator comprises a steel insert embedded in the insulator so as to prevent the strut bearing from being easily separated from the insulator. The strut bearing comprises an upper housing, a lower housing which is relatively rotated relative to the upper housing, and a bearing disposed between the upper housing and the lower housing. Further, so as to prevent foreign materials such as dust or water from being introduced into the bearing, the strut bearing comprises seal members installed at a radially inner side and a radially outer side of the bearing between the upper housing and the lower housing.

### SUMMARY

Since a conventional top mount assembly is configured such that seal members are installed in a strut bearing and then the strut bearing is fitted into an insulator, a manufacturing process of the top mount assembly is complicated and productivity thereof is degraded. In addition, since the insulator comprises a steel insert, a weight of the top mount assembly increases.

The present disclosure is directed to providing a top mount assembly having high productivity due to a simplified structure, and a manufacturing method thereof.

One aspect of the present disclosure provides a top mount assembly. The top mount assembly according to one embodiment may comprise an insulator comprising an elastic body and disposed between a vehicle body and a strut; and a strut bearing comprising an upper housing comprising at least one hole through which a portion of the elastic body passes, a lower housing, and a bearing disposed between the upper housing and the lower housing. The elastic body may comprise an elastic protrusion protruding downward from the hole. The lower housing may comprise a groove extending in a circumferential direction such that the elastic protrusion is inserted and located at a radially inner side of the bearing. The elastic protrusion may be inserted into the groove to seal between the upper housing and the lower housing at the radially inner side of the bearing.

In one embodiment, the elastic protrusion may have a ring shape.

In one embodiment, the hole may comprise a plurality of holes arranged in a circumferential direction of the upper housing.

In one embodiment, the insulator may further comprise an insert, and the elastic body may integrally couple the insert to the upper housing.

In one embodiment, the elastic body may be manufactured by insert curing molding.

In one embodiment, the upper housing may comprise a plurality of recesses intermittently disposed in the circumferential direction on an upper surface thereof.

In one embodiment, the upper housing may comprise at least one of an inner flange extending from an inner circumferential surface to a radially inner side and an outer flange extending from an outer circumferential surface to a radially outer side.

In one embodiment, the top mount assembly may further comprise a spring seat integrally coupled to the lower housing.

In one embodiment, the top mount assembly may further comprise a spring pad coupled to an outer side of the spring seat. At least a portion of the spring pad may be disposed between the upper housing and the lower housing at a radially outer side of the bearing to seal between the upper housing and the lower housing.

In one embodiment, the spring pad may comprise a flange extending to the radially outer side and having an outer side on which an upper end of a spring is located; and a seal lip formed on the flange and configured to seal between the upper housing and the lower housing.

In one embodiment, the elastic protrusion and the groove may have shapes complementary to each other. The elastic protrusion may be relatively slidable along the groove.

In one embodiment, the upper housing and the lower housing may be coupled to each other in a snap-fit method.

Another aspect of the present disclosure provides a top mount assembly. The top mount assembly may comprise an insulator disposed between a vehicle body and a strut; and a strut bearing comprising an upper housing comprising a groove extending in a circumferential direction on a lower surface thereoft a lower housing comprising a protrusion extending in the circumferential direction to be inserted into the groove, and a bearing disposed between the upper housing and the lower housing. The insulator may comprise an elastic body configured to integrally couple the insulator to the upper housing, and the protrusion may be inserted into the groove to seal between the upper housing and the lower housing at a radially inner side of the bearing.

In one embodiment, the protrusion may have a ring shape.

In one embodiment, the insulator may further comprise an insert. The elastic body may integrally couple the insert to the upper housing.

In one embodiment, the elastic body may be manufactured by insert curing molding.

In one embodiment, the upper housing may comprise a plurality of recesses intermittently disposed in the circumferential direction on an upper surface thereof.

In one embodiment, the upper housing may comprise at least one of an inner flange extending from an inner circumferential surface to a radially inner side and an outer flange extending from an outer circumferential surface to a radially outer side.

In one embodiment, the upper housing may comprise two outer flanges.

In one embodiment, the protrusion and the groove may have shapes complementary to each other, and the protrusion may be relatively slidable along the groove.

Another aspect of the present disclosure provides a manufacturing method of a top mount assembly. The manufacturing method of the top mount assembly may comprise manufacturing an upper housing comprising at least one hole, manufacturing an insulator comprising an elastic body which comprises an elastic protrusion protruding downward from the hole, manufacturing a lower housing comprising a groove which extends in a circumferential direction such that the elastic protrusion is inserted into the groove, arranging a bearing on the lower housing at a radially outer side of the groove, and coupling the upper housing to the lower housing such that the elastic protrusion is inserted into the groove to seal between the upper housing and the lower housing at a radially inner side of the bearing.

In one embodiment, in the manufacturing of the insulator, the elastic protrusion may have a ring shape.

In one embodiment, in the manufacturing of the insulator, the elastic body may be formed such that the elastic protrusion may protrude downward from the hole to integrally couple an insert to the upper housing.

In one embodiment, the manufacturing method of the top mount assembly may further comprise forming a spring seat to be integrally coupled to the lower housing by curing molding.

In one embodiment, the manufacturing method of the top mount assembly may further comprise forming a spring pad to be coupled to an outer side of the spring seat.

In one embodiment, in the coupling of the upper housing to the lower housing, the upper housing and the lower housing may be coupled to each other in a snap-fit method.

In accordance with a top mount assembly according to one embodiment and a manufacturing method thereof, a manufacturing of an insulator and a coupling of the insulator and an upper housing can be simultaneously achieved through formation of an elastic body, and thus the manufacturing process of the top mount assembly can be simplified. Further, an elastic protrusion of the elastic body is configured to be inserted into a groove formed in a lower housing to seal between the upper housing and the lower housing. Therefore, not only sealing performance between the upper housing and the lower housing can be secured with a simplified structure, but also a process of installing a separate seal member can be omitted. Consequently, the manufacturing process of the top mount assembly may be further simplified.

Further, since the insulator and the upper housing are integrally coupled to each other through the elastic body, there is no need for a steel insert to hold a strut bearing in the insulator. Consequently, a weight reduction of the top mount assembly can be achieved.

### DESCRIPTION OF DRAWINGS

FIG. 1 is a perspective view illustrating a top mount assembly according to one embodiment of the present disclosure.

FIG. 2 is an exploded perspective view illustrating the top mount assembly shown in FIG. 1.

FIG. 3 is an exploded perspective view illustrating an insulator shown in FIG. 2.

FIG. 4 is a perspective view illustrating a bottom portion of the insulator shown in FIG. 2.

FIG. 5 is an exploded perspective view illustrating a strut bearing shown in FIG. 2.

FIG. 6 is an enlarged perspective view illustrating an upper housing shown in FIG. 5.

FIG. 7 is a perspective view illustrating a bottom portion of the upper housing shown in FIG. 5.

FIG. 8 is a perspective view illustrating a bottom portion in a state in which the insulator shown in FIG. 4 and the upper housing shown in FIG. 5 are coupled.

FIG. 9 is an enlarged perspective view illustrating a lower housing shown in FIG. 5.

FIG. 10 is a cross-sectional view taken along line X-X shown in FIG. 1.

FIG. 11 is a partially enlarged view of FIG. 10.

FIG. 12 is a partially enlarged view illustrating a top mount assembly according to another embodiment of the present disclosure.

FIG. 13 is a partially enlarged view illustrating a top mount assembly according to still another embodiment of the present disclosure.

FIG. 14 is a flowchart illustrating a manufacturing method of a top mount assembly according to one embodiment of the present disclosure.

### DETAILED DESCRIPTION

Embodiments of the present disclosure are exemplified for the purpose of describing the technical spirit of the present disclosure. The scope of the claims according to the present disclosure is not limited to the embodiments described below or to the detailed descriptions of these embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising.” “including,” “having.” “taking.” and the like used herein should be construed as open-ended terms encompassing the possibility of including other embodiments.

The singular form described herein may include the plural form unless the context clearly indicates otherwise, and this is equally applied to the singular form set forth in the claims.

Direction indicating terms such as “upward,” “on,” and the like used herein are based on a direction in which an insulator is located with respect to a strut bearing in the accompanying drawings, and direction indicating terms “downward,” “below.” and the like mean a direction opposite the direction of the direction indicating terms such as “upward.” “on,” and the like. The insulator and the strut bearing shown in the accompanying drawings may be oriented differently, and the direction indicating terms may be construed accordingly.

Hereinafter, embodiments of the present disclosure will be described with reference to the accompanying drawings. In the accompanying drawings, the same reference numerals are assigned to the same or corresponding components. Further, in the following descriptions of the embodiments, duplicate descriptions of the same or corresponding components may be omitted. However, even though a description of a component is omitted, such a component is not intended to be excluded in any embodiment.

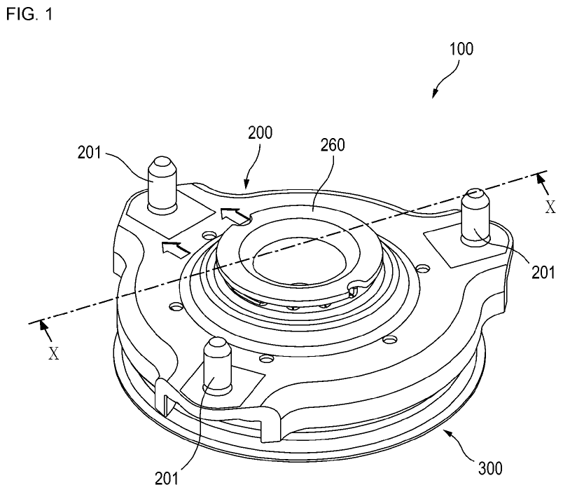

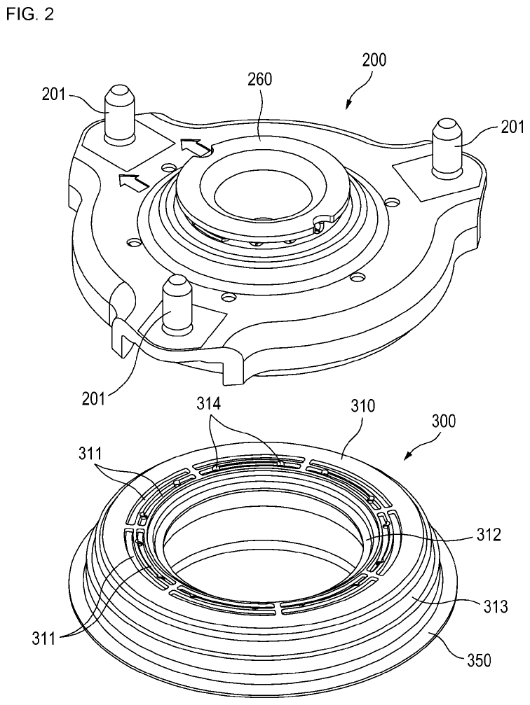

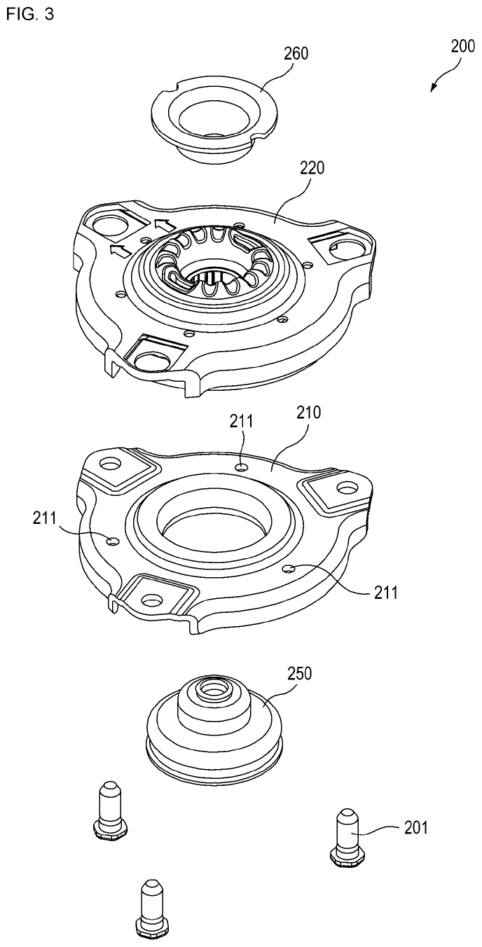

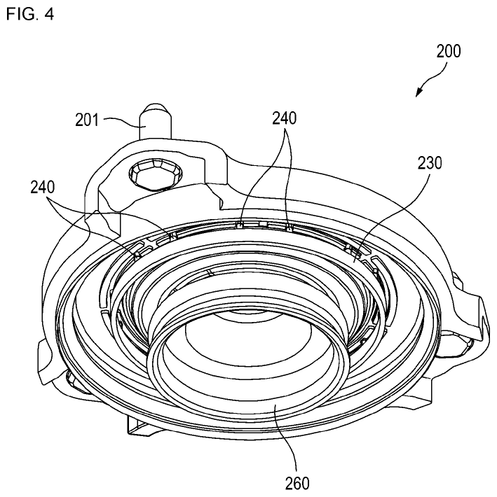

FIG. 1 is a perspective view illustrating a top mount assembly according to one embodiment of the present disclosure. FIG. 2 is an exploded perspective view illustrating the top mount assembly shown in FIG. 1. FIG. 3 is an exploded perspective view illustrating an insulator shown in FIG. 2. FIG. 4 is a perspective view illustrating a bottom portion of the insulator shown in FIG. 2.

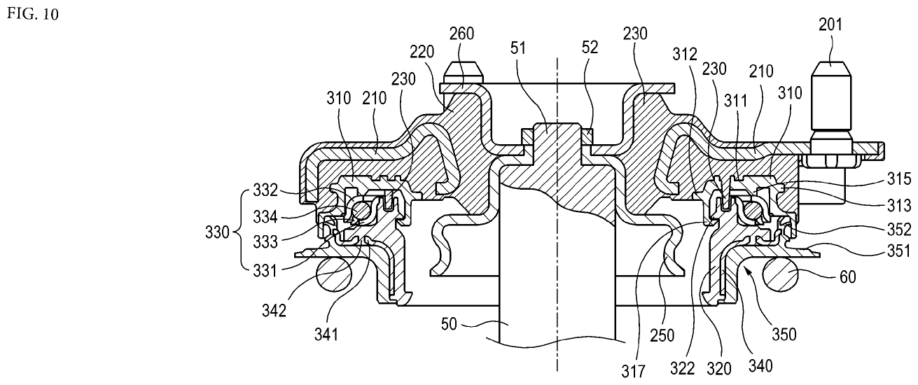

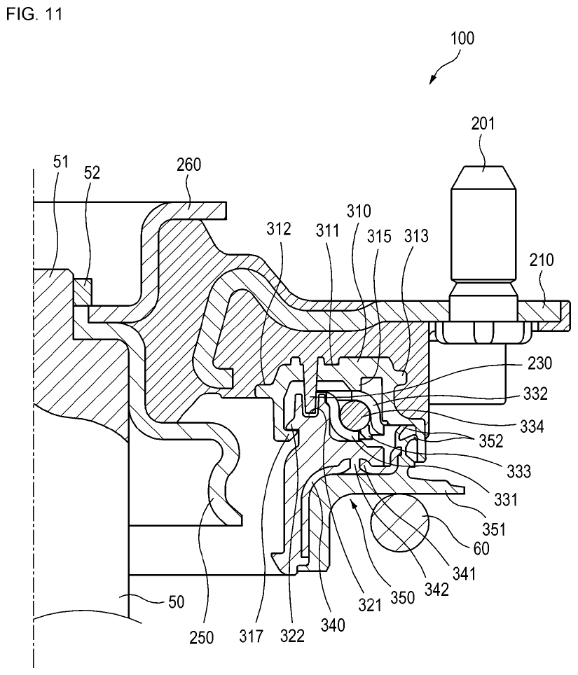

As shown in FIGS. 1 and 2, a top mount assembly 100 according to one embodiment of the present disclosure may comprise an insulator 200 and a strut bearing 300. The top mount assembly 100 is coupled to an upper end of a strut 50 (see FIGS. 10 and 11) and serves to reduce transfer of an impact or a vibration between the strut 50 and a vehicle body.

Referring to FIG. 3, the insulator 200 may comprise an insert 210 and an elastic body 220. A central portion of the insulator 200 is coupled to the strut 50 and a radially outer side portion thereof is coupled to the vehicle body by a plurality of bolts 201.

The insert 210 may form a frame of the insulator 200 and serve to reinforce rigidity of the insulator 200. The insert 210 may be made of a metal sheet, e.g., a high tension steel plate. The insert 210 may be completely embedded in the elastic body 220. In other words, the elastic body 220 may be formed to completely surround the insert 210. In one embodiment, the insert 210 may comprise a plurality of holes 211 disposed in a circumferential direction, and the elastic body 220 may be formed to pass through the plurality of holes 211. Further, the holes 211 may be filled with the elastic body 220. Consequently, a coupling force between the insert 210 and the elastic body 220 may be enhanced.

The elastic body 220 may also serve to integrally couple the insert 210 to an upper housing 310 of the strut bearing 300. The elastic body 220 may be interposed between the vehicle body and the insert 210 to prevent the insert 210 from being in direct contact with the vehicle body. Thus, the elastic body 220 may partially absorb an impact or a vibration transferred from the strut 50. For example, the elastic body 220 may be made of a rubber material. The elastic body 220 may be manufactured in a predetermined shape by curing molding. In one embodiment, the insulator 200 may be manufactured by curing molding the elastic body 220 in a state in which the insert 210 and the upper housing 310 are fixed to a mold so as to be spaced apart from each other. Here, curing (or vulcanization) refers to an operation of adding sulfur to raw rubber and heating the rubber to change elasticity. However, nowadays, the meaning of the curing (or vulcanization) is expanded to generally refer to an operation of change a plastic material (i.e., plastic) into an elastic material. The term “curing” is also called “vulcanization.”

In one embodiment, the elastic body 220 may comprise an elastic protrusion 230 and at least one connecting portion 240. As shown in FIG. 4, the elastic protrusion 230 may protrude downward from holes 314 of the upper housing 310 and have a ring shape. The elastic protrusion 230 may be inserted into a groove 321 of a lower housing 320 to seal between the upper housing 310 and the lower housing 320 at a radially inner side of a bearing 330. The elastic protrusion 230 may be configured to be relatively slidable along the groove 321 of the lower housing 320. The connecting portion 240 may extend from the elastic body 220 to connect the elastic protrusion 230 to the elastic body 220. A plurality of connecting portions 240 may be formed by filling in a plurality of holes 314 disposed in the upper housing 310 in a circumferential direction. The connecting portion 240 may have a circular rod shape. Alternatively, the connecting portion 240 may have a polygonal rod shape according to a cross-sectional shape of the hole 314 of the upper housing 310.

The elastic protrusion 230 and the connecting portions 240 may be formed together when the elastic body 220 is formed. For example, the elastic protrusion 230 may be manufactured together with the elastic body 220 by filling a material of the elastic body 220 in a space for an elastic protrusion, which is constituted of a mold used during the formation of the elastic body 220 and a lower surface of the upper housing 310. After a material of the elastic body 220 passes through the holes 314 of the upper housing 310 to completely fill in the space for the elastic protrusion, a material of the elastic body 220 fills in the holes 314 to form the connecting portions 240. The plurality of connecting portions 240 may be formed to spaced apart from each other in the circumferential direction. One elastic protrusion 230 may be connected to the below portions of the plurality of connecting portions 240 and may be continuously formed in the circumferential direction. Owing to the above-described configurations of the connecting portions 240 and the elastic protrusion 230, the upper housing 310 may be integrally coupled to the elastic body 220. Thus, the insulator 200 does not need to have a steel insert for holding and supporting the strut bearing 300, and it is possible to achieve a weight reduction of the top mount assembly 100. Further, the manufacturing of the insulator 200 and the coupling of the insulator 200 and the upper housing 310 may be simultaneously achieved in one process, for example, the process of curing molding the elastic body 220 in a state in which the insert 210 and the upper housing 310 are disposed in a mold. Consequently, the manufacturing process of the top mount assembly 100 may be simplified. Further, the elastic body 220 may be formed as a structure which will be described below so that the elastic body 220 may serve to seal between the upper housing 310 and the lower housing 320. Therefore, not only the manufacturing of the insulator 200 and the coupling of the insulator 200 and the upper housing 310 may be achieved through the formation of the elastic body 220, but also a process of installing separate seal members in the strut bearing as in the related art may be omitted, and thus the manufacturing process of the top mount assembly 100 may be further simplified.

In one embodiment, the insulator 200 may further comprise a lower cup 250 and an upper cup 260. The lower cup 250 and the upper cup 260 may be made of a metal sheet, e.g., a hot rolled steel sheet. A lower opening 251 may be formed at a center of the lower cup 250, and an upper opening 261 may be formed in the upper cup 260. The upper end of the strut 50 may be accommodated in the lower cup 250. A bolt 51 provided at the upper end of the strut 50 passes through the lower opening 251 and the upper opening 261, and a nut 52 may be screw-coupled to the bolt 51 passing through the upper opening 261. The strut 50 may be configured to be relatively rotated together with the lower housing 320 with respect to the insulator 200 and the upper housing 310.

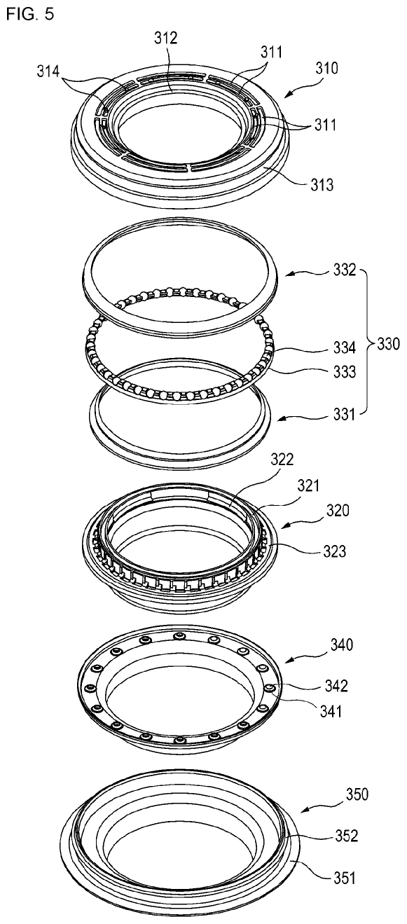

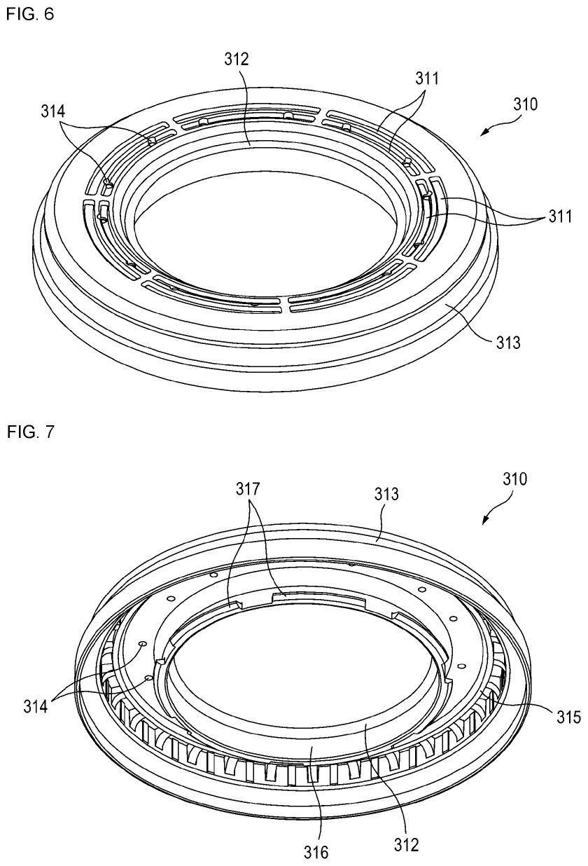

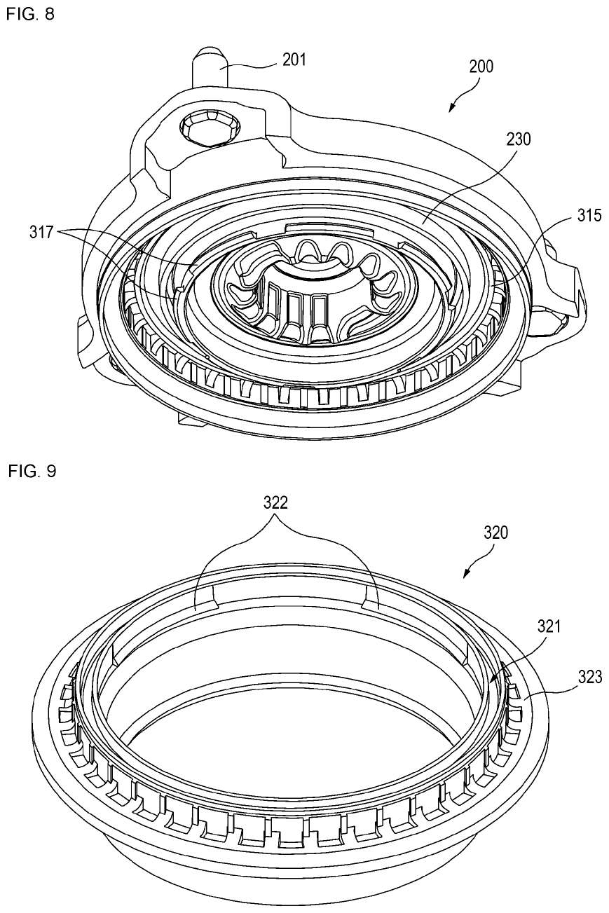

FIG. 5 is an exploded perspective view illustrating the strut bearing shown in FIG. 2. FIG. 6 is an enlarged perspective view illustrating the upper housing shown in FIG. 5. FIG. 7 is a perspective view illustrating a bottom portion of the upper housing shown in FIG. 5. FIG. 8 is a perspective view illustrating a bottom portion in a state in which the insulator shown in FIG. 4 and the upper housing shown in FIG. 5 are coupled. FIG. 9 is an enlarged perspective view illustrating the lower housing shown in FIG. 5. FIG. 10 is a cross-sectional view taken along line X-X shown in FIG. 1. FIG. 11 is a partially enlarged view of FIG. 10.

Referring to FIG. 5, the strut bearing 300 may comprise the upper housing 310, the lower housing 320, and the bearing 330. The strut bearing 300 is disposed below the insulator 200. The upper housing 310 and the lower housing 320 may be manufactured by injection molding a plastic material.

As shown in FIG. 6, in one embodiment, the upper housing 310 may comprise a plurality of recesses 311 intermittently disposed (i.e., spaced apart from each other) in the circumferential direction on an upper surface thereof. Since the upper housing 310 comprises the plurality of recesses 311, an area in which the elastic body 220 is in contact with the upper housing 310 may be increased. Consequently, a coupling force between the elastic body 220 and the upper housing 310 may be enhanced. In one embodiment, the plurality of recesses 311 may be formed in a plurality of rows to be spaced apart from each other in a radial direction such that it is possible to further enhance the coupling force between the elastic body 220 and the upper housing 310.

In one embodiment, the upper housing 310 may comprise at least one of an inner flange 312 extending from an inner circumferential surface to a radially inner side and an outer flange 313 extending from an outer circumferential surface to a radially outer side. The upper housing 310 may comprise both the inner flange 312 and the outer flange 313 or comprise any one of the inner flange 312 and the outer flange 313. Since the upper housing 310 comprises the inner flange 312 and the outer flange 313, an area in which the elastic body 220 is in contact with the upper housing 310 may be increased. Consequently, the coupling force between the elastic body 220 and the upper housing 310 may be enhanced.

As shown in FIGS. 6 and 7, the upper housing 310 may have at least one hole 314 through which a portion of the elastic body 220 passes. In one embodiment, a plurality of holes 314 may be disposed to spaced apart from each other in the circumferential direction. The elastic protrusion 230 may be formed to protrude downward from the plurality of holes 314. The plurality of holes 314 are filled with a portion of the elastic body 220 to form a plurality of connecting portions 240. As shown in FIG. 8, since the connecting portions 240 fill in the holes 314 in a state in which the insulator 200 and the upper housing 310 are coupled, the connecting portions 240 are not visible and the elastic protrusion 230 protrudes downward from the upper housing 310. Since the plurality of connecting portions 240 are connected or coupled to one elastic protrusion 230, holding forces between the connecting portions 240 and the elastic protrusion 230 and between the elastic body 220 and the upper housing 310 may be enhanced.

In one embodiment, as shown in FIG. 7, the upper housing 310 may comprise an extension 315 extending downward so as to be in contact with an upper side of the bearing 330. The extension 315 may pressurize the bearing 330 downward toward the lower housing 320 in a state in which the upper housing 310 and the lower housing 320 are coupled. Accordingly, the bearing 330 may be held and supported at a predetermined position between the upper housing 310 and the lower housing 320.

As shown in FIGS. 6 and 7, the upper housing 310 may comprise an upper hook 317 for the coupling with the lower housing 320. The upper hook 317 protrudes from an outer circumferential surface of a cylindrical portion 316 formed in an inner circumferential portion of the upper housing 310 to a radially outer side. A plurality of upper hooks 317 may be intermittently formed (i.e., spaced apart from each other) in the circumferential direction. Alternatively, the upper hook may be continuously formed in the circumferential direction.

As shown in FIG. 9, the lower housing 320 may comprise the groove 321 extending in the circumferential direction such that the elastic protrusion 230 is insertable into the groove 321. In one embodiment, the groove 321 and the elastic protrusion 230 may have shapes complementary to each other. The elastic protrusion 230 may be relatively slidable along the groove 321. For example, the elastic protrusion 230 may be convexly formed downward so as to have a generally quadrangular longitudinal section, and the groove 321 may be concavely formed downward from an upper end of the lower housing 320 so as to have a quadrangular longitudinal section. In a state in which the elastic protrusion 230 is inserted into the groove 321, a predetermined space or gap is formed between the elastic protrusion 230 and the groove 321. The space or gap may form a U-shaped flow path or a labyrinth structure from the upper end of the lower housing 320 along a convex portion of the elastic protrusion 230 or a concave portion of the groove 321. When the elastic protrusion 230 and the groove 321 are omitted, only a straight flow path crossing the elastic protrusion 230 along the radial direction may be formed. As shown in FIG. 11, the straight flow path corresponds to a radial width of the elastic protrusion 230, and the U-shaped flow path may have not only the straight flow path but also vertical length. Therefore, the U-shaped flow path may be configured to be about three times or more the length of the straight flow path when the elastic protrusion 230 and the groove 321 are omitted. Thus, in the radially inner side of the bearing 330, it is possible to effectively prevent movements of foreign materials such as dust or water, which are capable of infiltrating between the upper housing 310 and the lower housing 320, toward the bearing 330.

In one embodiment, the lower housing 320 may comprise a lower hook 322 coupled to the upper hook 317 of the upper housing 310. The lower hook 322 protrudes from an inner circumferential surface of the lower housing to a radially inner side. A plurality of lower hooks 322 may be intermittently formed (i.e., spaced apart from each other) in the circumferential direction. Alternatively, the lower hook may be continuously formed in the circumferential direction. In one embodiment, the upper housing 310 and the lower housing 320 may be coupled to each other in a snap-fit method. For example, the upper hook 317 protruding to the radially outer side and the lower hook 322 protruding to the radially inner side are mutually engaged with each other such that the upper housing 310 and the lower housing 320 may be coupled.

In one embodiment, the lower housing 320 may comprise a bearing seat 323 for supporting the bearing 330. The bearing seat 323 extends from an outer circumferential surface of the lower housing 320 to a radially outer side.

As shown in FIGS. 10 and 11, the bearing 330 may be disposed between the upper housing 310 and the lower housing 320 and may be located at a radially outer side of the groove 321. In other words, the groove 321 may be located at the radially inner side of the bearing 330. In one embodiment, the bearing 330 may comprise an inner ring 331, an outer ring 332, a retainer 333, and a plurality of balls 334. The inner ring 331 may be placed on the bearing seat 323. The outer ring 332 is spaced apart from the inner ring 331 and is relatively rotated with respect to the inner ring 331. A lower end of the extension 315 of the upper housing 310 may be placed on an upper end of the outer ring 332. The retainer 333 may be supported by the inner ring 331 and the bearing seat 323. The retainer 333 serves to maintain the plurality of balls 334 at predetermined intervals. The balls 334 may be supported by the retainer 333 and the inner ring 331. The balls 334 are rollable within the retainer 333.

In one embodiment, the top mount assembly 100 may further comprise a spring seat 340 integrally coupled to the lower housing 320. The spring seat 340 may be disposed on the outer circumferential surface of the lower housing 320. The spring seat 340 reinforces rigidity of the lower housing 320 and indirectly supports an upper end of a spring 60 which is disposed below thereof. The spring seat 340 may be made of a metal plate, e.g., a hot rolled steel sheet. During the formation of the lower housing 320, the spring seat 340 may be integrally maintained with the lower housing 320 by injecting a plastic material in a state in which the spring seat 340 is fixed to a mold. In one embodiment, the spring seat 340 may comprise a plurality of convex portions 341 which are arranged to be spaced apart from each other in the circumferential direction and are convex upward. Therefore, an area in which the lower housing 320 is in contact with the spring seat 340 is increased such that a coupling force between the lower housing 320 and the spring seat 340 may be enhanced. In one embodiment, the spring seat 340 may comprise a plurality of holes 342 arranged in the circumferential direction. The plurality of holes 342 may be respectively formed on the plurality of convex portions 341. The plastic injection material for the lower housing 320 fills in the plurality of holes 342 such that the coupling force between the lower housing 320 and the spring seat 340 may be further enhanced. Alternatively, the convex portions and the holes may be alternately disposed in the circumferential direction.

In one embodiment, the top mount assembly 100 may further comprise a spring pad 350 coupled to an outer side of the spring seat 340. At least a portion of the spring pad 350 may be disposed between the upper housing 310 and the lower housing 320 at a radially outer side of the bearing 330 and may seal between the upper housing 310 and the lower housing 320. The spring pad 350 may be made of a rubber material. The spring pad 350 may be manufactured by curing molding a rubber material in a state of being coupled to an outer circumferential surface of the spring seat 340 through an adhesive.

In one embodiment, the spring pad 350 may comprise a flange 351 and a seal lip 352. The flange 351 and the seal lip 352 may be manufactured by curing molding a rubber material in a state that the spring pad 350 is coupled to the outer circumferential surface of the spring seat 340. The flange 351 extends to a radially outer side, and the upper end of the spring 60 may be located on an outer side or an outer circumferential surface of the flange 351. The flange 351 may prevent noise due to friction between the lower housing 320 (or the spring seat 340) and the spring 60 and suppress transfer of an impact or a vibration from the spring 60 to the lower housing 320 (or the spring seat 340). The seal lip 352 may be formed on the flange 351 and may seal between the upper housing 310 and the lower housing 320 at the radially outer side of the bearing 330. A plurality of seal lips 352 may be formed to be in contact with the lower surface of the upper housing 310.

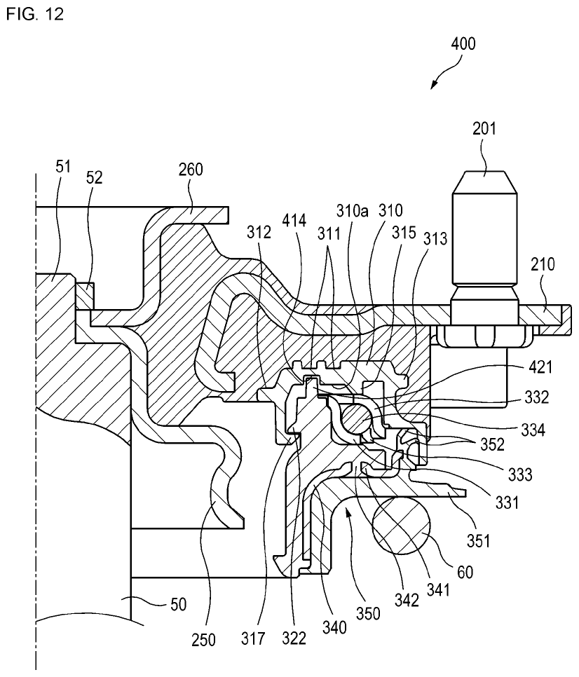

FIG. 12 is a partially enlarged view illustrating a top mount assembly according to another embodiment of the present disclosure.

Referring to FIG. 12, a top mount assembly 400 according to another embodiment of the present disclosure may comprise an insulator 200 and a strut bearing 300. The insulator 200 may comprise an insert 210 and an elastic body 220. The strut bearing 300 may comprise an upper housing 310, a lower housing 320, and a bearing 330. In the descriptions of the present embodiment, the same reference numerals are assigned to components which are the same as those of the top mount assembly 100 according to the embodiment shown in FIGS. 1 to 11, and detailed descriptions on the components will be omitted herein. Further, various modified embodiments of the top mount assembly 100 according to the embodiment shown in FIGS. 1 to 11 may be variously combined and applied to the top mount assembly 400 according to the embodiment shown in FIG. 12.

The elastic body 220 may integrally couple the insert 210 to the upper housing 310. The elastic body 220 may not comprise the elastic protrusion 230 according to the embodiment shown in FIGS. 1 to 11. The elastic body 220 may comprise connecting portions 240 so as to secure a coupling force with the upper housing 310. In this case, the elastic body 220 may be formed so as not to protrude from a lower surface 310a of the upper housing 310.

The upper housing 310 may comprise a groove 414 extending in the circumferential direction on the lower surface 310a. The groove 414 may be formed to be concave upward from the lower surface 310a of the upper housing 310.

The lower housing 320 may comprise a protrusion 421 extending in the circumferential direction so as to be inserted into the groove 414. The protrusion 421 may be inserted into the groove 414 to seal between the upper housing 310 and the lower housing 320 at a radially inner side of the bearing 330. The protrusion 421 may protrude from an upper end of the lower housing 320 and may have a ring shape. The protrusion 421 and the groove 414 may have shapes complementary to each other. The protrusion 421 may be configured to be relatively slidable along the groove 414. That is, the configurations of the protrusion 421 and the groove 414 according to the present embodiment may respectively correspond to those of the elastic protrusion 230 and the groove 321 according to the embodiments shown in FIGS. 1 to 11. Therefore, detailed descriptions on the configurations and effects of the protrusion 421 and the groove 414 will be omitted herein.

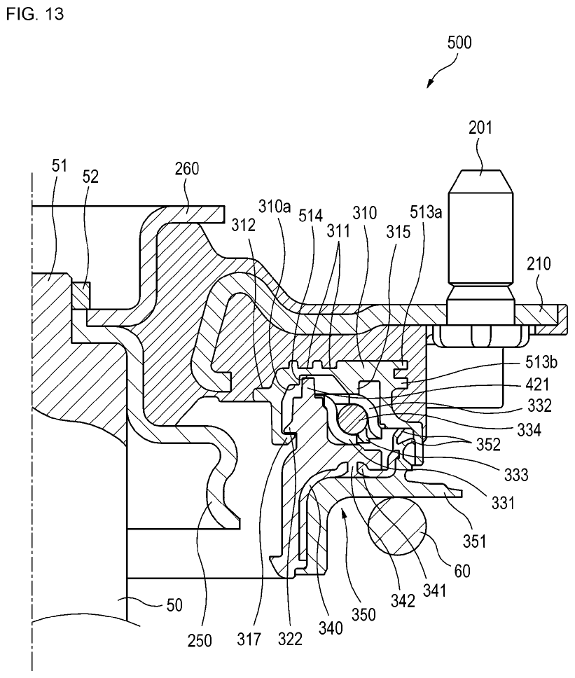

FIG. 13 is a partially enlarged view illustrating a top mount assembly according to still another embodiment of the present disclosure.

Referring to FIG. 13, a top mount assembly 500 according to still another embodiment of the present disclosure comprises an insulator 200 and a strut bearing 300. The insulator 200 may comprise an insert 210 and an elastic body 220. The strut bearing 300 may comprise an upper housing 310, a lower housing 320, and a bearing 330. In the descriptions of the present embodiment, the same reference numerals are assigned to components which are the same as those of the top mount assembly 400 according to the embodiment shown in FIG. 12, and detailed descriptions on the components will be omitted herein. Further, various modified embodiments of the top mount assembly 100 according to the embodiment shown in FIGS. 1 to 11 may be variously combined and applied to the top mount assembly 500 according to the embodiment shown in FIG. 13.

The upper housing 310 may comprise a groove 514 extending in the circumferential direction on a lower surface 310a. The groove 514 may be formed to be concave upward from the lower surface 310a of the upper housing 310. The groove 514 according to present embodiment may have a radial width that is longer than that of the groove 414 according to the embodiment shown in FIG. 12. That is, a radial length of the groove 514 may be formed to be longer than that of the protrusion 421. Further, the upper housing 310 may be easily coupled to the lower housing 320 such that the protrusion 421 of the lower housing 320 is inserted into the groove 514 of the upper housing 310.

In order to enhance a coupling force between the elastic body 220 and the upper housing 310, the upper housing 310 may comprise a plurality of outer flanges 513a and 513b. In the present embodiment, the plurality of outer flanges 513a and 513b may be formed as two flanges. The radial length of the outer flanges 513a and 513b according to the present embodiment may be formed to be longer than that of the outer flange 313 according to the embodiments shown in FIGS. 1 to 12. Consequently, the coupling force between the elastic body 220 and the upper housing 310 may be further enhanced.

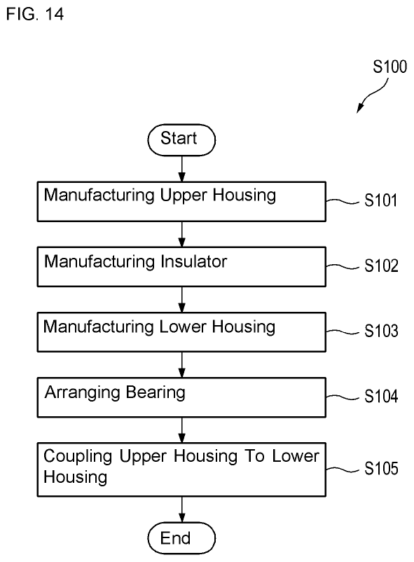

FIG. 14 is a flowchart illustrating a manufacturing method of a top mount assembly according to one embodiment of the present disclosure.

Although the process operations, the method operations, the algorithms, and the like have been described in a sequential order in the flowcharts shown in FIG. 14, such processes, methods, and algorithms may be configured to operate in any appropriate order. In other words, the operations of the processes, methods, and algorithms described in various embodiments of the present disclosure need not be performed in the order described in this disclosure. Further, although some operations are described as being performed asynchronously, in some embodiments, these some operations may be performed simultaneously. Moreover, illustration of the process shown in the drawings does not mean that the illustrated process excludes other alternations and modifications thereto, and it does not mean that the illustrated process or any among operations thereof essential to one or more of the various embodiments of the present disclosure and does not mean that the illustrated process is preferred.

Referring to FIG. 14, a manufacturing method S100 of a top mount assembly according to one embodiment of the present disclosure may comprise manufacturing an upper housing (S101), manufacturing an insulator (S102), manufacturing a lower housing (S103), arranging a bearing (S104), and coupling the upper housing to the lower housing (S105). The detailed configurations and functions of the top mount assembly 100 have been described in detail with reference to the embodiments shown in FIGS. 1 to 13, and thus detailed descriptions thereof will be omitted below.

As one embodiment, in the manufacturing of the upper housing (S101), the upper housing 310 may be manufactured to comprise at least one hole 314 through which a portion of the elastic body 220 may pass.

As another embodiment, in the manufacturing of the upper housing (S101), the upper housing 310 may be manufactured to comprise the groove 414 and 514 which extends in the circumferential direction on the lower surface 310a thereof and is formed concavely upward from the lower surface 310a thereof.

In the manufacturing of the insulator (S102), the insulator 200 may be manufactured so as to comprise the elastic body 220 having the elastic protrusion 230 which protrudes downward from the hole 314. In one embodiment, the elastic protrusion 230 may have a ring shape. In one embodiment, the elastic body 220 may be formed such that the elastic protrusion 230 protrudes downward from the hole 314 to integrally couple the insert 210 to the upper housing 310.

As one embodiment, in the manufacturing of the lower housing (S103), the lower housing 320 may be manufactured to comprise the groove 321 which extends in the circumferential direction such that the elastic protrusion 230 is inserted into the groove 321.

As another embodiment, in the manufacturing of the lower housing (S103), the lower housing 320 may be manufactured to comprise the protrusion 421 which extends in the circumferential direction so as to be inserted into the grooves 414 and 514.

In one embodiment, the manufacturing of the lower housing (S103) may further comprise forming a spring pad by curing molding. In the forming the spring pad by curing molding, the spring seat 340 may be formed by curing molding to be integrally coupled with the lower housing 320 in a state of being fixed to a mold.

In the arranging of the bearing (S104), the bearing 330 may be disposed on the lower housing 320 at the radially outer side of the groove 321.

In the coupling of the upper housing to the lower housing (S105), the protrusion 230 may be inserted into the groove 321 to seal between the upper housing 310 and the lower housing 320 at a radially inner side of the bearing 330. In the coupling of the upper housing to the lower housing (S105), the upper housing 310 and the lower housing 320 may be coupled to each other in a snap-fit method.

The manufacturing method of the top mount assembly S100 according to one embodiment may further comprise forming a spring pad. In the forming of the spring pad, the spring pad 350 may be formed to be coupled to an outer side or an outer circumferential surface of the spring seat 340. The forming of the spring pad may be performed after the manufacturing of the lower housing (S103).

Although the technical spirit of the present disclosure has been described by way of some embodiments and examples shown in the accompanying drawings, it should be noted that various substitutions, modification, and alterations can be devised by those skilled in the art to which the present disclosure pertains without departing from the technical spirit and scope of the present disclosure. Further, it should be construed that these substitutions, modifications, and variations are included within the scope of the appended claims.

What is claimed is:

1. A top mount assembly comprising:
an insulator comprising an elastic body and disposed between a vehicle body and a strut; and
a strut bearing comprising an upper housing comprising at least one hole through which a portion of the elastic body passes; a lower housing; and a bearing disposed between the upper housing and the lower housing, wherein
the elastic body comprises an elastic protrusion protruding downward from the hole,
the lower housing comprises a groove extending in a circumferential direction such that the elastic protrusion is inserted and located at a radially inner side of the bearing, and
the elastic protrusion is inserted into the groove to seal between the upper housing and the lower housing at the radially inner side of the bearing.

2. The top mount assembly of claim 1, wherein the elastic protrusion has a ring shape.

3. The top mount assembly of claim 1, wherein the hole comprises a plurality of holes arranged in a circumferential direction of the upper housing.

4. The top mount assembly of claim 1, wherein:
the insulator further comprises an insert; and
the elastic body integrally couples the insert to the upper housing.

5. The top mount assembly of claim 4, wherein the elastic body is manufactured by insert curing molding.

6. The top mount assembly of claim 5, wherein the upper housing comprises a plurality of recesses intermittently disposed in the circumferential direction on an upper surface thereof.

7. The top mount assembly of claim 5, wherein the upper housing comprises at least one of an inner flange extending from an inner circumferential surface to a radially inner side and an outer flange extending from an outer circumferential surface to a radially outer side.

8. The top mount assembly of claim 1, further comprising:
a spring seat integrally coupled to the lower housing; and
a spring pad coupled to an outer side of the spring seat,
wherein at least a portion of the spring pad is disposed between the upper housing and the lower housing at a radially outer side of the bearing to seal between the upper housing and the lower housing.

9. The top mount assembly of claim 8, wherein the spring pad comprises a flange extending to the radially outer side and having an outer side on which an upper end of a spring is located; and a seal lip formed on the flange and configured to seal between the upper housing and the lower housing.

10. The top mount assembly of claim 1, wherein the elastic protrusion and the groove have shapes complementary to each other, and the elastic protrusion is relatively slidable along the groove.

11. The top mount assembly of claim 1, wherein the upper housing and the lower housing are coupled to each other in a snap-fit method.

12. A top mount assembly comprising:
an insulator disposed between a vehicle body and a strut; and
a strut bearing comprising an upper housing comprising a groove extending in a circumferential direction on a lower surface thereof; a lower housing comprising a protrusion extending in the circumferential direction to be inserted into the groove;
and a bearing disposed between the upper housing and the lower housing, wherein the insulator comprises an elastic body configured to integrally couple the insulator to the upper housing, and
wherein the protrusion is inserted into the groove to seal between the upper housing and the lower housing at a radially inner side of the bearing.

13. The top mount assembly of claim 12, wherein the protrusion has a ring shape.

14. The top mount assembly of claim 12, wherein the upper housing comprises two outer flanges extending from an outer circumferential surface to a radially outer side.

15. The top mount assembly of claim 12, wherein the protrusion and the groove have shapes complementary to each other, and the protrusion is relatively slidable along the groove.

16. A manufacturing method of a top mount assembly, comprising:
manufacturing an upper housing comprising at least one hole;
manufacturing an insulator comprising an elastic body which comprises an elastic protrusion protruding downward from the hole;
manufacturing a lower housing comprising a groove which extends in a circumferential direction such that the elastic protrusion is inserted into the groove;
arranging a bearing on the lower housing at a radially outer side of the groove; and
coupling the upper housing to the lower housing such that the elastic protrusion is inserted into the groove to seal between the upper housing and the lower housing at a radially inner side of the bearing.

17. The manufacturing method of claim 16, wherein, in the manufacturing of the insulator, the elastic protrusion has a ring shape.

18. The manufacturing method of claim 16, wherein, in the manufacturing of the insulator, the elastic body is formed such that the elastic protrusion protrudes downward from the hole to integrally couple an insert to the upper housing.

19. The manufacturing method of claim 16, further comprising:
forming a spring seat to be integrally coupled to the lower housing by curing molding; and
forming a spring pad to be coupled to an outer side of the spring seat.

20. The top mount assembly of claim 16, wherein, in the coupling of the upper housing to the lower housing, the upper housing and the lower housing are coupled to each other in a snap-fit method.
